(19) United States
(12) Patent Application Publication
(10) Pub. No.: US 2025/0280216 A1
(43) Pub. Date: Sep. 4, 2025

(54) Software-Reconfigurable Optical Routing Architecture for Adaptive AI Computation

(71) Applicant: LARRY LIM KHENG CHEONG, SINGAPORE (SG)

(72) Inventor: LARRY LIM KHENG CHEONG, SINGAPORE (SG)

(21) Appl. No.: 19/204,536

(22) Filed: May 11, 2025

(51) Int. Cl. H04Q 11/00

(52) U.S. Cl. CPC H04Q 11/0005; H04Q 11/0062; H04Q 2011/003; H04Q 2011/0039

(57) ABSTRACT

This invention relates to an artificial intelligence (AI) processor architecture that employs software-reconfigurable optical pathways for internal data routing. Unlike conventional chips with fixed electrical or photonic interconnects, this design enables dynamic light-based routing controlled by software to optimize data movement across cores, accelerators, and memory. A photonic mesh composed of tunable waveguides and optical switches is managed by a reconfiguration algorithm in the chip's control plane. Path topology adapts based on workload type or phase (e.g., training vs. inference) to reduce latency, congestion, and energy use through photonic parallelism. Switching elements include phase-change materials, optical MEMS, or electro-optic modulators. Routing maps are defined in real time via software APIs, supporting neural architecture switching and mixed AI workloads. This hybrid architecture delivers real-time self-optimization, adaptive bandwidth control, and energy-efficient parallel computation, suited for datacenters, edge AI, and autonomous platforms.

### FIELD OF THE INVENTION

The present invention relates to hardware systems for artificial intelligence (AI) acceleration. More specifically, it pertains to dynamically reconfigurable photonic routing architectures, whereby on-chip light pathways are modified in real time in response to AI workload changes.

### BACKGROUND OF THE INVENTION

Modern AI processors rely on tightly packed electrical interconnects for data transmission between compute cores, memory, and accelerators. These traditional routing fabrics face bandwidth and power limitations due to crosstalk, latency, and resistive heating.

Photonic interconnects, by contrast, offer low-latency and high-throughput pathways using light. However, conventional photonic chips suffer from static routing limitations, typically being fixed during chip fabrication and unable to respond to runtime workload variation.

There is an unmet need for an AI chip that provides adaptive, software-driven reconfiguration of its optical routing paths, reducing congestion and optimizing latency and thermal profiles on demand. This invention addresses that need.

### SUMMARY OF THE INVENTION

The invention, as described in claim 1, comprises:
(a) An optical mesh interconnect of waveguides linking AI compute cores, memory, and accelerators.
(b) A plurality of optical switching elements such as electro-optic modulators, phase-change materials, and MEMS shutters (see FIG. 2) embedded throughout the mesh to steer photonic signals.
(c) A reconfiguration control unit that dynamically programs signal paths based on workload needs (FIG. 3).
(d) A software interface that enables dynamic, workload-specific reconfiguration (claims 1, 4, 5, 6).

FIG. 1 shows the overall system layout: AI compute blocks and accelerators are interconnected by a software-controlled optical mesh.

### BRIEF DESCRIPTION OF THE DRAWINGS

FIG. 1 shows a block-level diagram of the AI processor, where compute elements and memory are optically connected through a software-configurable mesh.

FIG. 2 illustrates key optical switching technologies:
(a) Electro-optic modulators
(b) Phase-change-based routing nodes
(c) MEMS-based shutters

FIG. 3 demonstrates how routing decisions are dynamically managed via metadata classification and neural architecture analysis.

FIG. 4 provides deployment scenarios including datacenter, edge computing, and automotive neural processors.

FIG. 5 visualizes routing reconfiguration over time, from training to inference, as defined in method claims 11-13.

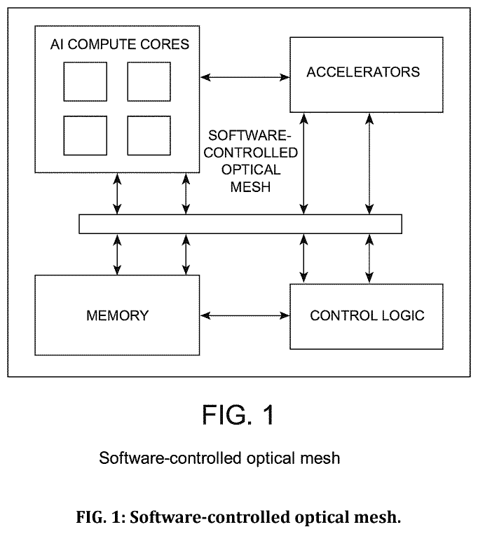

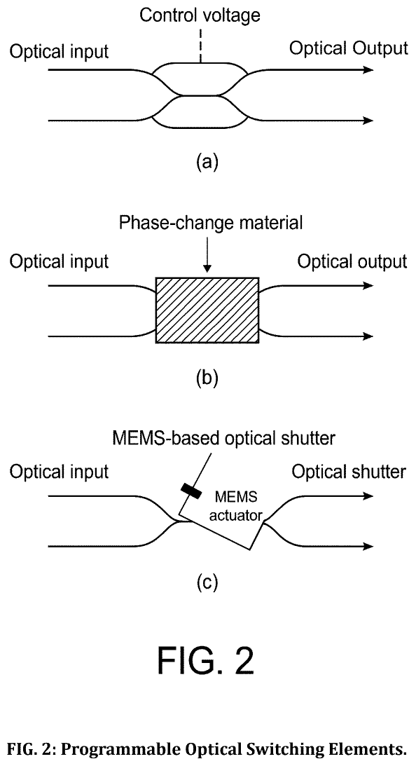

### DETAILED DESCRIPTION OF THE INVENTION

### Photonic Routing Mesh

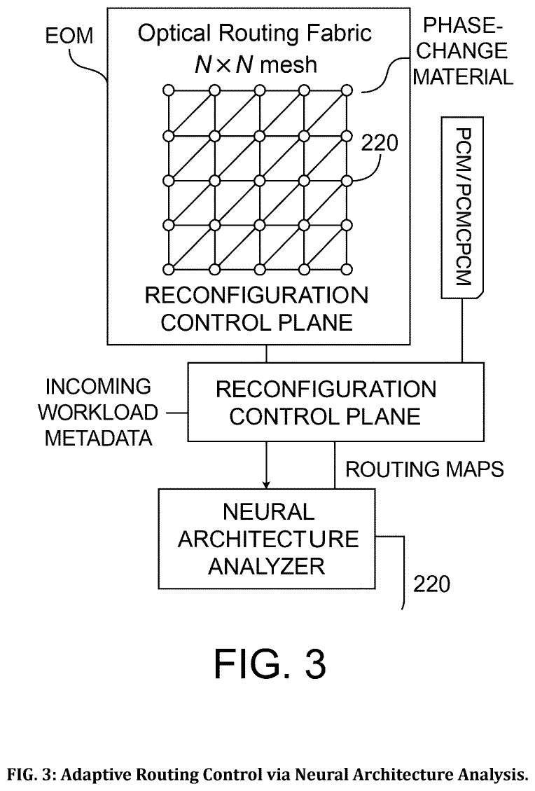

The invention utilizes an N×NN\times N mesh (FIG. 3) of optical waveguides with wavelength division multiplexing (WDM) and mode division multiplexing (MDM) capabilities (claim 10). Each junction node embeds a reconfigurable optical switch.

### Switching Technologies

Three types of switches are supported:
Electro-optic modulators (FIG. 2a, claim 2)
Phase-change materials (FIG. 2b, claim 3)
MEMS shutters (FIG. 2c, claim 4)

Each switch alters optical paths under the control of thermal, electrical, or mechanical stimuli.

### Dynamic Reconfiguration Logic

As per claim 5, a neural architecture classifier (FIG. 3) determines model type (CNN, RNN, transformer) (claim 6) and generates routing maps that are pushed to the control layer in real time.

Reconfiguration is performed by a software layer interfacing with hardware control registers (claims 1(d), 14(a)).

### Thermal and Power Adaptation

Integrated temperature sensors (claim 8) monitor local heating. Phase stability is ensured by regulating power or bypassing congested routes. Lossy optical paths are corrected using amplifier boosts only when necessary.

### Deployment Use Cases

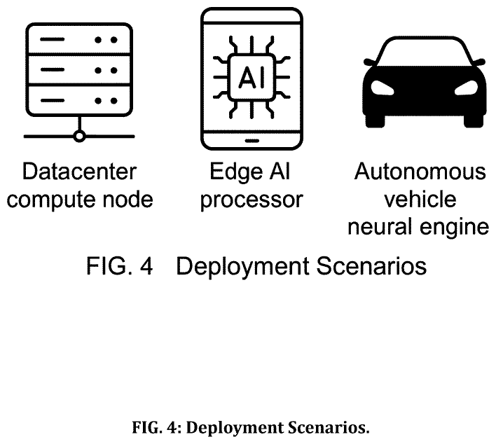

FIG. 4 presents key scenarios:
Datacenter training systems
Edge inference chips (claim 15)
Autonomous vehicles using embedded AI cores

### Execution Phase Adaptation

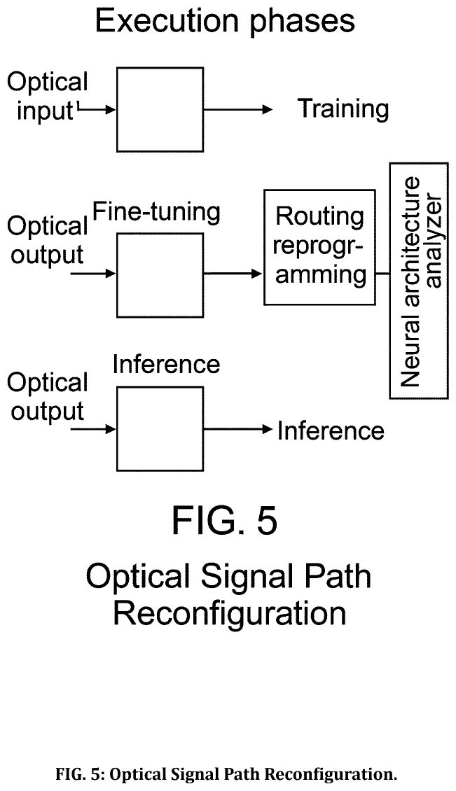

As shown in FIG. 5, reconfiguration occurs across execution stages: training, fine-tuning, and inference (claim 11). The neural architecture analyzer feeds back performance metrics such as latency or signal loss (claim 13), reprogramming routes in real time (claim 12).

### CONCLUSION

This software-reconfigurable photonic AI architecture enables dynamic control of data movement across chip subsystems. It improves routing efficiency and AI throughput while adapting to model types and computation phases.

The invention supports hybrid software-hardware control (claim 14(c)) and is compatible with advanced packaging for deployment in space-, energy-, and latency-constrained environments.

1. An artificial intelligence (AI) processor chip comprising:
(a) a mesh of optical waveguides arranged to route light-based signals between processing cores, memory blocks, or accelerators;
(b) a plurality of optical switching elements embedded within said mesh, wherein each element is configured to modify photonic signal paths in response to control signals;
(c) a reconfiguration control unit configured to program said optical switching elements based on a routing map;
(d) and a software interface enabling dynamic redefinition of said routing map in response to workload characteristics or execution phase.

2. The AI processor chip of claim 1, wherein the optical switching elements comprise electrooptic modulators configured to redirect or attenuate optical signals based on applied voltage.

3. The AI processor chip of claim 1, wherein the optical switching elements comprise phase-change materials whose refractive index is modified thermally or electrically to control light paths.

4. The AI processor chip of claim 1, wherein the optical switching elements comprise microelectromechanical system (MEMS) actuators for mechanically altering optical signal direction.

5. The AI processor chip of claim 1, further comprising a workload classifier configured to determine the neural network architecture type and to generate a corresponding routing map.

6. The AI processor chip of claim 5, wherein the workload classifier distinguishes between convolutional neural networks (CNNs), recurrent neural networks (RNNs), and transformer-based models.

7. The AI processor chip of claim 1, wherein the routing map is generated based on at least one of: traffic congestion, thermal load, optical loss budget, or computation phase.

8. The AI processor chip of claim 1, further comprising temperature sensors integrated within the chip and a thermal feedback loop for routing path optimization.

9. The AI processor chip of claim 1, wherein the reconfiguration control unit comprises an on-chip microcontroller or field-programmable gate array (FPGA).

10. The AI processor chip of claim 1, wherein the photonic routing mesh supports wavelength division multiplexing (WDM) and mode division multiplexing (MDM).

11. A method for adaptive photonic routing in an AI processor chip, comprising:
identifying an AI workload type and generating metadata;
computing a routing graph for data flow across chip components;
reconfiguring a plurality of optical switching elements in an on-chip optical mesh using said routing graph; and
executing AI tasks with real-time routing path modifications based on operational feedback.

12. The method of claim 11, wherein reconfiguring the optical switching elements comprises altering the refractive index of phase-change materials.

13. The method of claim 11, wherein operational feedback includes latency, energy usage, signal loss, or cache miss rate.

14. A system for photonic AI computation comprising:
(a) a software API layer for issuing routing commands;
(b) a reconfigurable optical hardware mesh for on-chip data movement;
(c) a hybrid control logic block combining software and firmware to optimize routing paths during model training or inference phases.

15. The system of claim 14, configured for deployment in datacenters, edge inference units, autonomous systems, or AR/VR devices requiring low-latency AI execution.
